(19) United States
(12) Patent Application Publication
(10) Pub. No.: US 2026/0208661 A1
(43) Pub. Date: Jul. 23, 2026

(54) MICRO-LEDS FOR HEADLIGHT WITH EVENT DETECTION

(71) Applicant: VueReal Inc., Waterloo (CA)

(72) Inventors: Gholamreza CHAJI, Waterloo (CA); John CRONIN, Jericho, VT (US)

(73) Assignee: VueReal Inc., Waterloo, ON (CA)

(21) Appl. No.: 19/141,924

(22) PCT Filed: Dec. 21, 2023
(86) PCT No.: PCT/CA2023/051740

§ 371 Date: Jun. 20, 2025

Related U.S. Application Data
(60) Provisional application No. 63/477,061, filed on Dec. 23, 2022.

(51) Int. Cl. B60Q 1/14; B60Q 1/00; F21S 41/153; F21S 41/19; F21S 41/663

(52) U.S. Cl. CPC B60Q 1/143; B60Q 1/0023; B60Q 1/0088; F21S 41/153; F21S 41/19; F21S 41/663; B60Q 2900/50

(57) ABSTRACT

A Micro-LED-based vehicle headlight. Micro-LEDs may be arranged in a panel with density to create the same or similar intensity light as existing headlight designs or to conform with legal requirements. These Micro-LED headlights may allow for cheaper, more energy efficient, smaller, and/or more customizable headlights. The Micro-LED headlight may be automatically changed into different modes, such as high beams or fog lights, based on the driving conditions detected by sensors.

### BACKGROUND AND FIELD OF THE DISCLOSURE

The present disclosure is generally related to Micro-LEDs and their use in automotive applications.

Traditional vehicle headlights are limited to providing basic illumination and do not offer advanced features or capabilities.

Many current headlight setups cannot run advanced applications or be modified.

Many traditional vehicle headlights do not have advanced safety features such as flashing or color-shifting, which may help pedestrians and wildlife better identify an oncoming vehicle.

Creating custom applications for vehicle headlights is a complex process that may require specialized knowledge and equipment.

Traditional vehicle headlights may not be suitable for use in low light or adverse weather conditions, requiring drivers to manually switch between modes such as high beams and fog lights.

### SUMMARY

The present invention relates to a method to alter a state of a Micro-LED panel the method comprising, having the Micro-LED panel comprised of a plurality of Micro-LEDs, having a substrate to which a Micro-LED tile is bound, having a connector that allows the electronics of the Micro-LED panel to integrate with a vehicle, and having a sensor, wherein the Micro-LED panel performs a function of a vehicle headlight, and wherein a state of the Micro-LED panel is altered based on data from the sensor.

### DESCRIPTIONS OF THE DRAWINGS

FIG. 1: Illustrates an integration of a transferred microdevice with an electro-optical thin film device in a hybrid structure, according to an embodiment.

FIG. 2: Illustrates a Micro-LED panel for a headlight, according to an embodiment.

FIG. 3: Illustrates an Event Module, according to an embodiment.

FIG. 4: Illustrates an Event Database, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples. The present invention and disclosure discloses a structure, a system and a method to integrate Micro-LED with vehicle lighting system and Micro-LED based sensor system

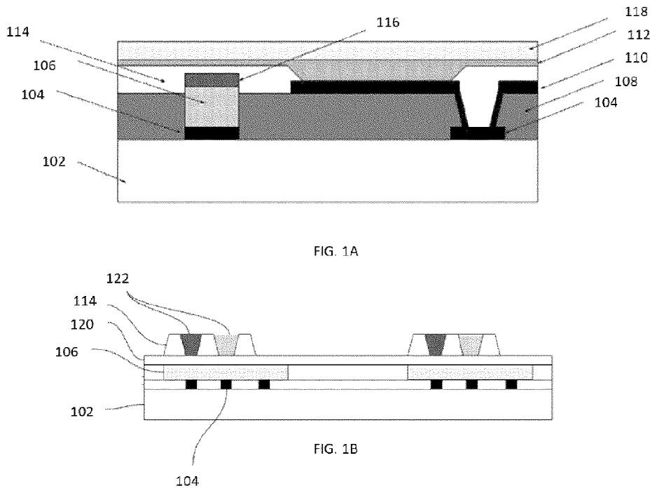

FIG. 1A shows an example of integrating a transferred microdevice 106 with an electro-optical thin film device 112 in a hybrid structure. This is an example of an integrated Micro-LED tile that is later picked and placed into an array of tiles. It should be obvious to those in the art there are many ways to create Micro-LED tiles and integrate them in an array of tiles, as per US20160218143A1—Microdevice integration into system substrate. A receiver substrate 102 and contact pads 104 upon which the microdevice 106 arrays are transferred and into which the thin film electro-optical device is integrated in a number of hybrid structure embodiments. Microdevice 106 may be transferred and bonded to the bonding pad 104 of the receiver substrate 100. In one case, a dielectric layer 108 is formed over the substrate 102 to cover the exposed electrodes and conductive layers. Lithography and etching may be used to pattern the dielectric layer 108. Conductive layer 110 is then deposited and patterned to form the bottom electrode of the thin film electro-optical device 112. If there is no risk of unwanted coupling between bottom electrode 110 and other conductive layers in the receiver substrate, the dielectric layer 108 may be eliminated. However, this dielectric layer can also act as a planarization layer to offer better fabrication of electro-optical devices 112. A bank layer 114 is deposited on the substrate 102 to cover the edges of the electrode 110 and the microdevice 106. Thin film electro-optical device 112 is then formed over this structure. Organic LED (OLED) devices are an example of a thin film electro-optical device that may be formed using different techniques, including but not limited to shadow mask, lithography, and printing patterning. Finally, the top electrode 118 of the electro-optical thin film device 112 is deposited and patterned if needed. In an embodiment where the microdevices'106 thickness is significantly high, cracks or other structural problems may occur within the bottom electrode 110. In these embodiments, a planarization layer may be used in conjunction with or without the dielectric layer 108 to address this issue. In another embodiment, the microdevice 106 can have a device electrode 116. This electrode can be common between other microdevices 106 in the system substrate. In this case, the planarization layer (if present) and/or bank structure 114 covers the electrode 116 to avoid any shorts between the electro-optical device 112 and device electrode 116.

FIG. 1B illustrates structures where the device is shared between a few pixels (or sub-pixels) after post-processing to deposit a common electrode and color conversion layers. Here the microdevice 106 is not fully patterned, but the horizontal condition is engineered so that the contacts 104 define the area allocated to each pixel. The system substrate 102 with contact pads 104 and a donor substrate with microdevices 106. After the microdevices 106 are transferred to system substrate 102, one can do post-processing, such as depositing common electrode 120, color conversion layers 122, color filters, and so on. However, the methods described in this disclosure and other possible methods can be used. It is possible to add the color conversion layers as described into pixel (or sub-pixel) active areas after forming the active area. This can offer a higher fill factor and higher performance and avoid color leaking from the side pixel (or sub-pixel) if the active area of the pixel (or sub-pixel) is covered by reflective layers. The microdevices 106 are grown on a buffer/sacrificial layer in another embodiment.

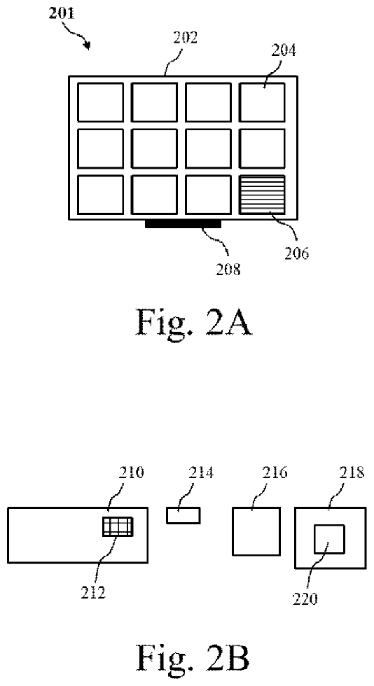

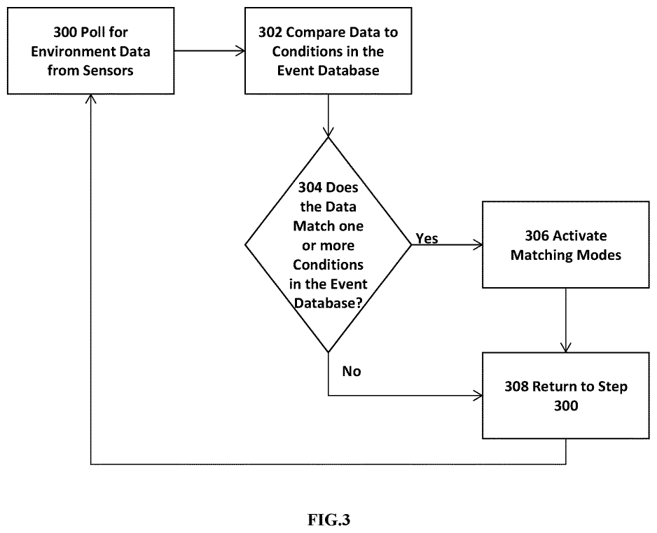

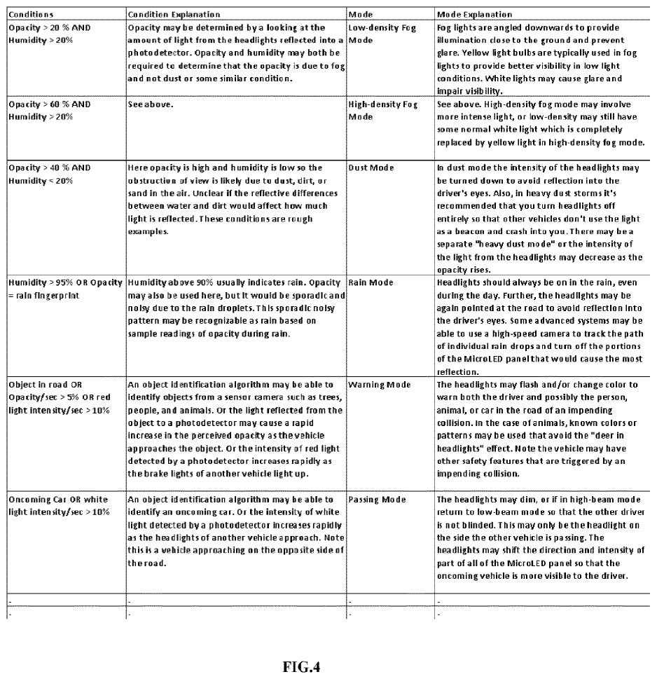

FIG. 2A displays a Micro-LED panel for a headlight. FIG. 2B displays a system that changes the Micro-LED panel's state based on sensors'detected events, such as fog, rain, dust, road hazards, and oncoming traffic. Element 202 may be a Micro-LED panel which may be comprised of one or more tiles that contain multiple Micro-LEDs. Multiple small Micro-LED tiles can be integrated together into a larger flat plate. The panel may contain Micro-LEDs in the density to create the same light as the existing headlights. The panel may use RGB Micro-LEDs or Blue Micro-LEDs with Phosphorus to get white light. Element 204 may be a substrate to which the Micro-LED tiles may be bound. The substrate may be silicon, glass, sapphire, any other substrate known in the art, any material to which Micro-LED tiles can be bound, or any combination of these materials. The substrate may further house or be bound to electronics which connect to the Micro-LEDs. These electronics may be contained within the substrate, tunnel through the substrate to reach the Micro-LEDs, or use the substrate as part of the circuit. Element 206 may be a Micro-LED tile comprised of multiple Micro-LEDs. Element 208 may be a connector which allows the electronics of the Micro-LED panel of FIG. 2A to connect to the electronics system of the vehicle. This may allow the Micro-LED panel to be powered and controlled by the vehicle and to give feedback information to the vehicle. Element 210 may be a memory unit that stores data. Data stored in the memory unit may include data from sensors and any memory required to run the event module of FIG. 3 and the event database 106 of FIG. 4. Element 212 may be the event module of FIG. 3. Element 214 may be a processor that runs the event module of FIG. 3. Element 216 may be a bus controller which handles communication between the processor, memory, sensors, and Micro-LED panel. Element 218 may be the Micro-LED panel of FIG. 2A. Element 220 may be a sensor or plurality of sensors that detect road and environmental data. This data is compared to the data in the event database of FIG. 4 by the event module of FIG. 3. If the data is a close enough match to data on a known event, the event module may cause a change in the state of the Micro-LED panel. For example, a humidity sensor picks up a high level of humidity. This high level is compared to known events in the event database. Based on the known data, the event is identified as “low-density fog.” The event module may then change the Micro-LED panel to fog-light mode, changing the color and intensity of the light omitted accordingly. Possible sensors that may make up element 220 include, but are not limited to, photodetectors, microphones, humidity detectors, cameras, piezoelectric sensors, or another sensor that may collect data relevant to road or weather conditions. The sensors may include devices that emit light or sound so that the reflection can be detected, such as with sonar or radar. One of the key benefits of using Micro-LEDs in vehicle headlights is that they can be easily customized to offer advanced features and capabilities. This is because Micro-LEDs can be individually controlled and used to create specific lighting patterns. This means that they can be used to create advanced safety features such as flashing or color-shifting, which can help pedestrians and wildlife better identify an oncoming vehicle. Another benefit of Micro-LEDs is that they can be used in low light or adverse weather conditions. This is because they are very bright and have a fast response time, so they can quickly switch between lighting modes, such as high beams and fog lights. This can help improve visibility for drivers and make driving in poor conditions safer. Micro-LEDs have the potential to solve many of the issues associated with traditional vehicle headlights by providing advanced features and capabilities, improving safety, and increasing visibility in low light or adverse weather conditions.

FIG. 3 displays the event module. The process may begin with the event module polling, at step 300, for data from the sensors 220. This data may be, for example, humidity, percentage of light reflected (in the case of fog, dust, rain, or an upcoming obstacle), temperature, speed of the vehicle, speed of oncoming objects, etc. Some of this data may be interpreted from other data. For example, the percentage of reflected light increasing rapidly may provide data on the speed of an obstacle ahead, a spike in red light detection may indicate a leading vehicle is braking, or an increasing intensity of non-reflected white light may indicate an oncoming vehicle. The event module may compare, at step 302, the data to conditions in the event database. These conditions may be simple ranges of values, such as humidity >70% or percentage of light reflected >20%, or may be interpreted conditions such as oncoming vehicle or road hazards. The event module may determine, at step 304, if the data matches any of the conditions in the event database. For example, if humidity is 73%, it matches the condition “humidity>70%”. The match may not need to be an exact match. Conditions may have multiple match requirements which may be required for or contribute to a match. For example, a condition may match a humidity >80% but may also match a humidity >60% and a temperature below >10° C. If there are no matches, the event module may skip to step 308. If the data matches a condition in the event database, the event module may activate, at step 306, the associated mode. For example, data matching a condition of humidity >70% and opacity >10% may trigger “low-density fog mode,” which may cause the Micro-LED panel to emit light that better penetrates fog. The Micro-LED may be in multiple modes at once if they don't interfere. For example, being in both “low-density fog mode” and “warning mode” could cause the Micro-LED panel to emit light that better penetrates fog while also intermittently flashing red. The event module may deactivate the mode if the mode is already active, but the conditions are no longer met. The event module may return, at step 308, to step 300.

FIG. 4. displays the event database. The event database contains conditions that may match data from the sensors. When these conditions are met, the event module will change the Micro-LED panel to the associated mode in the event database. FIG. 4 also contains columns that explain the conditions and modes.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A method to alter a state of a Micro-LED panel the method comprising:
having the Micro-LED panel comprised of a plurality of Micro-LEDs,
having a substrate to which a Micro-LED tile is bound,
having a connector that allows the electronics of the Micro-LED panel to integrate with a vehicle, and
having a sensor, wherein the Micro-LED panel performs a function of a vehicle headlight, and
wherein a state of the Micro-LED panel is altered based on data from the sensor.

2. The method of claim 1, wherein a first element is a sensor or plurality of sensors that detect road and environmental data wherein further the data is compared to the data in an event database of an event module.

3. The method of claim 2, wherein a second element is a processor that runs the event module.

4. The method of claim 3, wherein a third element is a memory unit that stores data wherein further, the data stored in the memory unit includes data from sensors and any memory required to run the event module and the event database.

5. The method of claim 4, wherein a fourth element is a bus controller which handles communication between the processor, memory, sensors, and Micro-LED panel.

6. The method of claim 5, wherein the if the data matches to a data on a known event, the event module causes a change in the state of the Micro-LED panel.
